(19) United States
(12) Patent Application Publication
(10) Pub. No.: US 2008/0195750 A1
(43) Pub. Date: Aug. 14, 2008

(54) SECURE CROSS PLATFORM AUDITING

(75) Inventors: Vladimir Sadovsky, Redmond, WA (US); Robin A. Alexander, Redmond, WA (US); Oren Rosenbloom, Redmond, WA (US); Hubert Van Hoof, Seattle, WA (US)

Correspondence Address: MICROSOFT CORPORATION, ONE MICROSOFT WAY, REDMOND, WA, 98052-6399, US

(73) Assignee: Microsoft Corporation, Redmond, WA (US)

(21) Appl. No.: 11/673,473

(22) Filed: Feb. 9, 2007

(51) Int. Cl. G06F 15/16

(52) U.S. Cl. 709/234

(57) ABSTRACT

A method and apparatus is described for recording or auditing events. In one example, a device is connected to a first host device and may receive data from the first host device. The first host device may further be connected in a network of devices. The device may be disconnected from the first host device and may be connected to a second host device, the second host device not being fully connected to the network. The device may store data and may further contain a log file in memory for tracking or auditing events that occur associated with the data and/or associated with the second host device. The log file may be transferred to the first host device after the device is re-connected with the first host device.

### BACKGROUND

Removable storage devices have become increasingly popular. Users may transfer data from one computing device to another computing device by connecting portable storage devices to one computing device and moving/copying information from the computing device onto the portable storage device. The portable storage device may then be connected to a second computing device and this information may be transferred to the second computing device.

Also, other actions or events may be applied to information obtained from a network computing device. These actions or events may be performed on a remote computing device that has no connection or is not in communication with the network computing device or the network in which the network computing device is connected. In this case, any action or event performed on the remote computing device is not recorded in a network computing device.

Similarly, storage devices may be used in the transfer of data between computing devices in a network and computing devices that are not in the network. When connected to a non-network computing device, actions and events that are performed may not be detected in the network. As such, inaccuracies in data and asset auditing may result. Similarly, events leading to changes in state of security sensitive parameters shared between portable storage device and disconnected computing device may be lost.

### SUMMARY

The following presents a simplified summary of the disclosure in order to provide a basic understanding to the reader. This summary is not an extensive overview of the disclosure and it does not identify key/critical elements of the invention or delineate the scope of the invention. Its sole purpose is to present some concepts disclosed herein in a simplified form as a prelude to the more detailed description that is presented later.

In one example, a method is described for tracking events in which data may be received from a network device and events associated with a non-network device or partial non-network device may be logged in a log file, firmware dataset, or any other storage medium. The log file may further be output to a network device.

In another example, the log file may be stored in a portion of memory with restricted access.

In another example, the non-network or partial non-network device may be authenticated. The authentication may be based on identity of the device or identity of a user of the device.

In yet another example, a device is described for connecting to a first or second host device and recording events in a log file, protected firmware dataset, or any other storage medium.

Many of the attendant features will be more readily appreciated as the same becomes better understood by reference to the following detailed description considered in connection with the accompanying drawings.

### DESCRIPTION OF THE DRAWINGS

The present description will be better understood from the following detailed description read in light of the accompanying drawings, wherein:

FIG. 1 illustrates an example of a suitable computing system environment 100 on which a method of auditing of events, states, or any activity may be implemented.

FIG. 2 illustrates an example of a network in which multiple devices are fully connected to the network.

FIG. 3 illustrates an example of a device that is partially connected or intermittently connected to a network.

FIG. 4 illustrates an example of a non-connected device that is not connected to a network.

FIG. 5 illustrates an example of a non-connected device and a fully-connected device of a network.

FIG. 6 illustrates an example of a device for tracking actions and/or events associated with data in a system.

FIG. 7 illustrates an example of a log file.

FIG. 8 is a block diagram illustrating one example of auditing of information.

FIG. 9 is a flowchart illustrating one example of auditing.

FIG. 10 is a flowchart illustrating an example of updating an audit log in a network.

FIG. 11 is a flowchart illustrating another example of auditing events or activities.

Like reference numerals are used to designate like parts in the accompanying drawings.

### DETAILED DESCRIPTION

The detailed description provided below in connection with the appended drawings is intended as a description of the present examples and is not intended to represent the only forms in which the present example may be constructed or utilized. The description sets forth the functions of the example and the sequence of steps for constructing and operating the example. However, the same or equivalent functions and sequences may be accomplished by different examples.

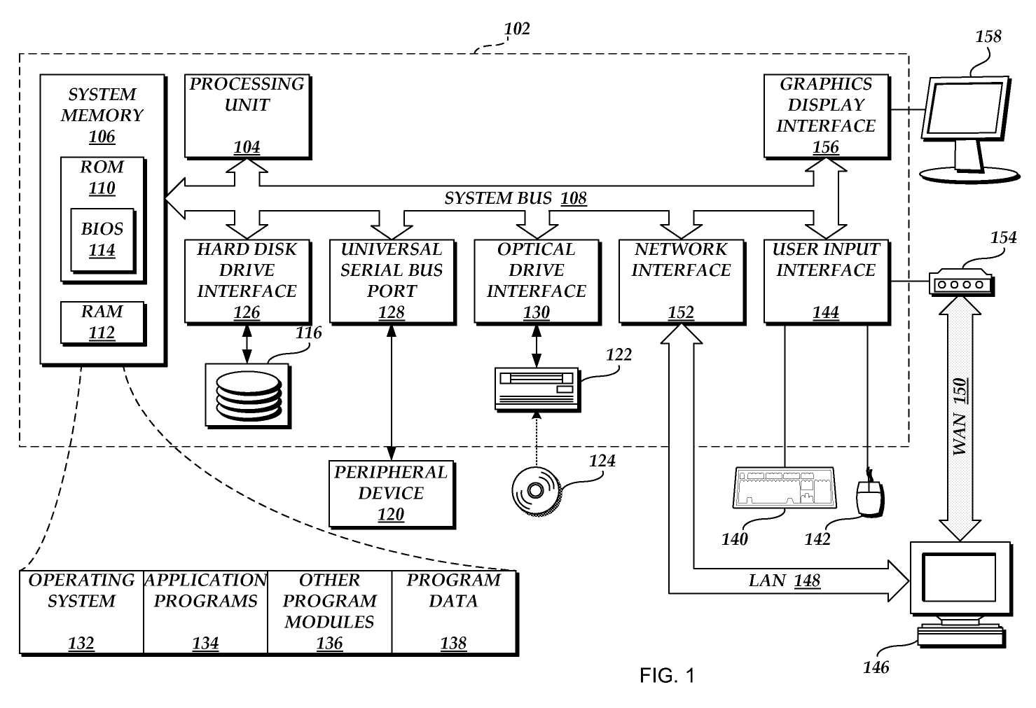

FIG. 1 illustrates an example of a suitable computing system environment on which computing methods may be implemented. The computing system environment is only one example of a suitable computing environment and is not intended to suggest any limitation as to the scope of use or functionality of the invention. Neither should the computing environment be interpreted as having any dependency or requirement relating to any one or combination of components illustrated in the exemplary operating environment.

The invention is operational with numerous other general purpose or special purpose computing system environments or configurations. Examples of well known computing systems, environments, and/or configurations that may be suitable for use with the invention include, but are not limited to, personal computers, server computers, hand-held or laptop devices, multiprocessor systems, microprocessor-based systems, set top boxes, programmable consumer electronics, network PCs, minicomputers, mainframe computers, distributed computing environments that include any of the above systems or devices, and the like.

The invention may be described in the general context of computer-executable instructions, such as program modules, being executed by a computer. Generally, program modules include routines, programs, objects, components, data structures, etc. that perform particular tasks or implement particular abstract data types. The invention may also be practiced in distributed computing environments where tasks are performed by remote processing devices that are linked through a communications network. In a distributed computing environment, program modules may be located in both local and remote computer storage media including memory storage devices.

With reference to FIG. 1, an exemplary system for implementing the invention includes a general purpose computing device in the form of a computer 102. Components of computer 102 may include, but are not limited to, a processing unit 104, a system memory 106, and a system bus 108 that couples various system components including the system memory to the processing unit 104. The system bus 108 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

Computer 102 typically includes a variety of computer readable media. Computer readable media can be any available media that can be accessed by computer 102 and includes both volatile and nonvolatile media, removable and non-removable media. By way of example, and not limitation, computer readable media may comprise computer storage media. Computer storage media includes both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can accessed by computer 102. In addition, computer storage media may include a removable storage device. The removable storage device may be connected to the computer and may receive data from the computer. The data received from the computer may be stored on the removable storage device which may be disconnected from the computer. The removable storage device may be used to transfer data from one computer or computer system to another. In one example, the removable storage device may include a USB flash disk. Combinations of the any of the above should also be included within the scope of computer readable storage media.

The system memory 106 includes computer storage media in the form of volatile and/or nonvolatile memory such as read only memory (ROM) 110 and random access memory (RAM) 112. A basic input/output system 114 (BIOS), containing the basic routines that help to transfer information between elements within computer 102, such as during start-up, is typically stored in ROM 110. RAM 112 typically contains data and/or program modules that are immediately accessible to and/or presently being operated on by processing unit 104. By way of example, and not limitation, FIG. 1 illustrates operating system 132, application programs 134, other program modules 136, and program data 138.

The computer 102 may also include other removable/non-removable, volatile/nonvolatile computer storage media. By way of example only, FIG. 1 illustrates a hard disk drive 116 that reads from or writes to non-removable, nonvolatile magnetic media and an optical disk drive 122 that reads from or writes to a removable, nonvolatile optical disk 124 such as a CD ROM or other optical media. These are merely examples of removable/non-removable, volatile/nonvolatile computer storage media. For example, the computer 102 may also include a magnetic disk drive (not shown) that reads from or writes to a removable, nonvolatile magnetic disk (not shown). Additionally or alternatively, other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 116 is typically connected to the system bus 108 through a non-removable memory interface such as interface 126 and optical disk drive 122 may be connected to the system bus 108 by a removable memory interface, such as interface 130. Additionally or alternatively, a magnetic disk drive may be connected to the system bus 108 by a removable memory interface such as a magnetic drive interface (not shown).

In addition, the computer 102 may contain a Universal Serial Bus (USB) port 128 through which a peripheral device 120 may be connected. In one example, a portable storage device may be connected to the computer 102 via the USB port 128. The portable storage device may be any portable device that may be removable from the computer 102 and may be connected to another computer or computer system. Data from one computer may be transferred to another computer via the portable storage device (e.g., peripheral device 120). One example of a portable storage device may include a flash disk.

The drives and their associated computer storage media discussed above and illustrated in FIG. 1, provide storage of computer readable instructions, data structures, program modules and other data for the computer 102. Alternatively or additionally, computer storage devices may be portable storage devices that may store data. For example, the computer 102 may contain data stored in system memory 106. The stored data may be transferred via system bus 108 to the peripheral device 120 via the USB port 128. In this example, the peripheral device 120 includes a portable storage device that may be connected or disconnected from the computer 102. For example, the portable storage device (e.g., peripheral device 120) may be connected to the USB port 128 of computer 102. Data stored in the system memory 106 is transferred via the system bus 108 to the USB port 128. The data is further transferred via the USB port 128 to the portable storage device and stored therein. The portable storage device (e.g., peripheral device 120) may be disconnected or removed from computer 102. Additionally, the portable storage device (e.g., peripheral device 120) may be reconnected to another computer or computer system. Data may thus be transferred between different computers or computer systems via the portable storage device (e.g., peripheral device 120).

In FIG. 1, for example, hard disk drive 116 is illustrated as storing operating system 132, application programs 134, other program modules 136, and program data 138. Note that these components can either be the same as or different from additional operating systems, application programs, other program modules, and program data, for example, different copies of any of the elements. A user may enter commands and information into the computer through input devices such as a keyboard 140 and pointing device 142, commonly referred to as a mouse, trackball or touch pad. Other input devices (not shown) may include a microphone, joystick, game pad, satellite dish, scanner, or the like. These and other input devices are often connected to the processing unit 104 through a user input interface 144 that is coupled to the system bus, but may be connected by other interface and bus structures, such as a parallel port, game port or a universal serial bus (USB). A monitor 158 or other type of display device is also connected to the system bus 108 via an interface, such as a video interface or graphics display interface 156. In addition to the monitor 158, computers may also include other peripheral output devices such as speakers (not shown) and printer (not shown), which may be connected through an output peripheral interface (not shown).

The computer 102 may operate in a networked environment using logical connections to one or more remote computers, such as a remote computer. The remote computer may be a personal computer, a server, a router, a network PC, a peer device or other common network node, and typically includes many or all of the elements described above relative to the computer 102. The logical connections depicted in FIG. 1 include a local area network (LAN) 148 and a wide area network (WAN) 150, but may also include other networks. Such networking environments are commonplace in offices, enterprise-wide computer networks, intranets and the Internet.

When used in a LAN networking environment, the computer 102 is connected to the LAN 148 through a network interface or adapter 152. When used in a WAN networking environment, the computer 102 typically includes a modem 154 or other means for establishing communications over the WAN 150, such as the Internet. The modem 154, which may be internal or external, may be connected to the system bus 108 via the user input interface 144, or other appropriate mechanism. In a networked environment, program modules depicted relative to the computer 102, or portions thereof, may be stored in the remote memory storage device. By way of example, and not limitation, remote application programs may reside on a memory device. It will be appreciated that the network connections shown are exemplary and other means of establishing a communications link between the computers may be used.

Those skilled in the art will realize that storage devices utilized to store program instructions can be distributed across a network. For example, a remote computer may store an example of the process described as software. A local or terminal computer may access the remote computer and download a part or all of the software to run the program. Alternatively, the local computer may download pieces of the software as needed, or execute some software instructions at the local terminal and some at the remote computer (or computer network). Those skilled in the art will also realize that by utilizing conventional techniques known to those skilled in the art that all, or a portion of the software instructions may be carried out by a dedicated circuit, such as a DSP, programmable logic array, or the like.

In another example, a computer-readable medium having computer-executable instructions stored thereon is provided in which execution of the computer-executable instructions performs a method as described herein. The computer-readable medium may be included in a system or computer and may include, for example, a hard disk, a magnetic disk, an optical disk, a CD-ROM, etc. A computer-readable medium may also include any type of computer-readable storage media that can store data that is accessible by computer such as random access memories (RAMs), read only memories (ROMs), and the like.

A method and system for tracking or auditing actions or events or providing a record of events or state changes in a computing system is described. Any number of host devices may be connected in a network. Host devices may include any device that manages resources in a computing environment. For example, a host device may manage resources on a peripheral device connected to the host device. In this case, a host device may be a computer that runs an operating system. Any number of other devices (e.g., peripheral devices) may be connected to the host device. For example a portable storage device may be connected to the host device. Information or resources may be managed by the host device such that the information or resources may be transferred from the host device to the connected device (e.g., the portable storage device).

Host devices may be connected in a network and may be in communication with other host devices that are also connected in the network. Other host devices may not be connected to the network and, therefore, actions taken by those host devices not connected to the network may not be known to host devices that are connected to the network. For example, a first computer may be connected to a network of other computers. Actions taken on the first computer may be monitored by any of the other computers connected to the network. However, if a second computer is not connected to the network, then actions taken on the second computer may not be known to the computers that are connected in the network.

In this example, a user of a computer connected to the network may desire information on activities performed on a computer that is not connected to the network. The computer not connected to the network may be connected to the network at certain times but disconnected or removed from the computer at other times. In this case, a user of the computer may roam between computers or computer systems. At certain times, the user may be connected to the network and may perform certain activities. During these times, other computers that are connected to the network may receive information about the activities performed. However, when the user of the computer disconnects or removes the computer from the network and roams to another computer, computer system, or device, the activities and actions taken while not connected to the network (or connected to the other computer, computer system or device) may not be known to computers connected to the original network. In one example, the activities, events or actions taken while the user of the computer is roaming on other networks or connected to other devices may be audited and received at another device in another network.

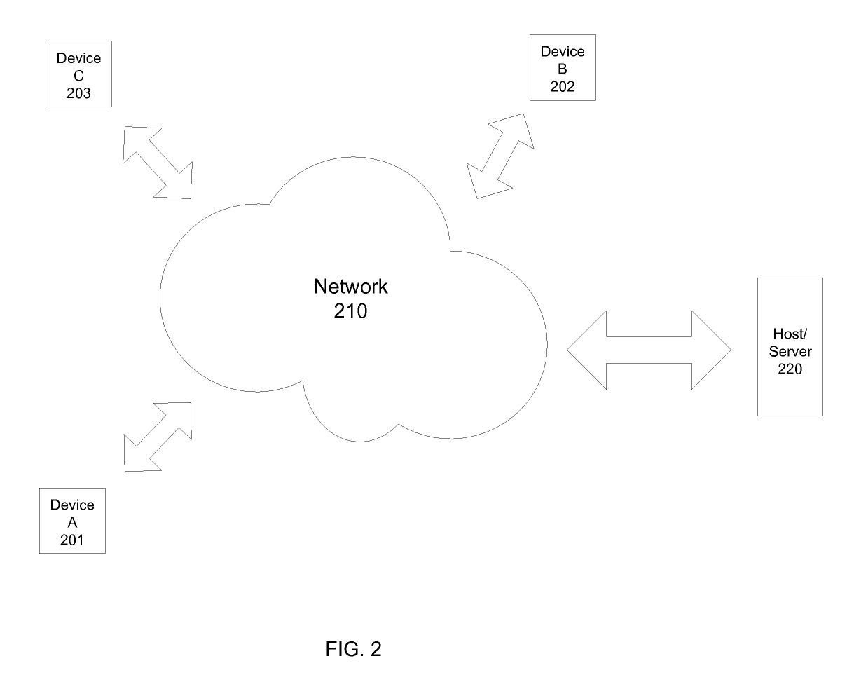

FIG. 2 illustrates an example of a network in which multiple devices such as host device are fully connected to the network. In this example, the network 210 includes host devices such as Device A 201, Device B 202 and Device C 203. Any number and any type of devices may be included in the network 210 and may manage resources in a computing environment. In addition, a host/server 220 may also be connected to the network. In one example, the host/server 220 may maintain a record of activities and events in the network. For example, when an event occurs at device A 201, the event may be detected and recorded at the host/server 220.

Also, host devices may be partially or intermittently connected to the network. In this example, a host device such as a computer may be connected to the network at certain times or under certain conditions but may also be disconnected from the network during other times or under other conditions. For example, a corporate laptop computer may be connected to a corporate network and may share data with other computers or host device that are connected to the corporate network. The corporate laptop computer may further be disconnected from the corporate network and may also be connected to other networks, if desired. Hence, the corporate laptop computer may be connected to the corporate network at certain times or under certain conditions (e.g., when the user connects the laptop to the network) but may also be disconnected from the network (e.g., when the user disconnects the computer from the network to use elsewhere).

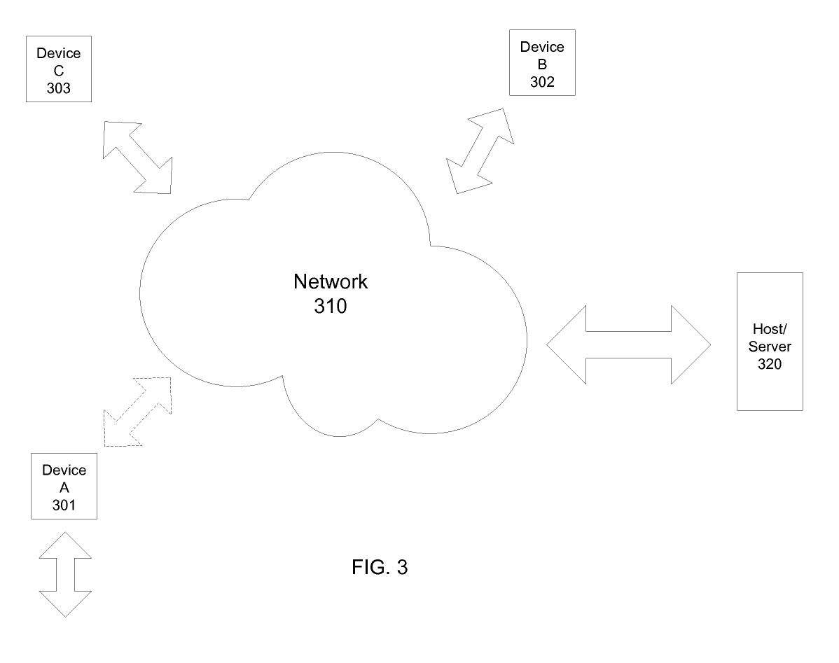

FIG. 3 illustrates an example of a host device that is partially connected or intermittently connected to a network. As FIG. 3 illustrates, a network 310 may include host devices such as device A 301, device B 302, device C 303 and host/server 320. The network 310 of FIG. 3 is merely an example as any number or any type of host devices may be connected to the network. In this example, device A 301 is intermittently or partially connected to the network 310 as depicted by the dotted arrow. Thus, device A 301 may be connected to the network 310 during certain times or under certain conditions but may also be disconnected from the network 310, if desired. Also, device A 301 may be connected to other networks, if desired.

When device A 301 is connected to network 310 in this example, any activity such as events, state changes, document manipulation, data access, etc. may be detected or recorded on another device connected to the network 310. For example, host/server 320 may detect or record an event at device A 301 in which data on device A 301 is accessed by a user. The event may further be recorded in a log stored at host 320. Also in this example, if device A 301 is disconnected from the network 310, activities performed in conjunction with device A 301 may not be detected by devices connected to the network 310 that are not connected to device A 301. For example, if device A 301 is disconnected from network 310 and data is subsequently accessed on device A 301, host/server 320 may not detect the accessing of data on device A 301 at the time the data is accessed if device A 301 is not connected to the network 310 or to host/server 320 at the time the data is accessed.

In addition, host devices may be non-connected to a network such that the non-connected host device does not communicate with host devices in the network. For example, a corporate computer being used by an employee in the corporation may be connected to a corporate network but a home computer of the employee may not be connected to the corporate network. In this example, the home computer does not communicate with the corporate network and does not receive information from or transmit information to the host devices that are connected to the corporate network.

In another example, data may be transferred between a host device in the corporate network and a non-connected host device by transferring the data to an intermediate, portable device or storage. For example, data may be copied from a host device that is connected to the corporate network onto a storage medium such as a floppy disc or CD-ROM. The storage medium may then be removed from the host device connected to the corporate network and inserted into the home computer. Data may be copied from the storage medium onto the home computer. The user may further modify, print, or otherwise manipulate the data on the home computer and save the manipulated data back onto the storage medium. In another example, the data stored on the storage medium may include executable data. In this case, the executable data on the storage medium may be executed to perform an activity on a computer. The activity may further be recorded or audited in a log on the storage medium.

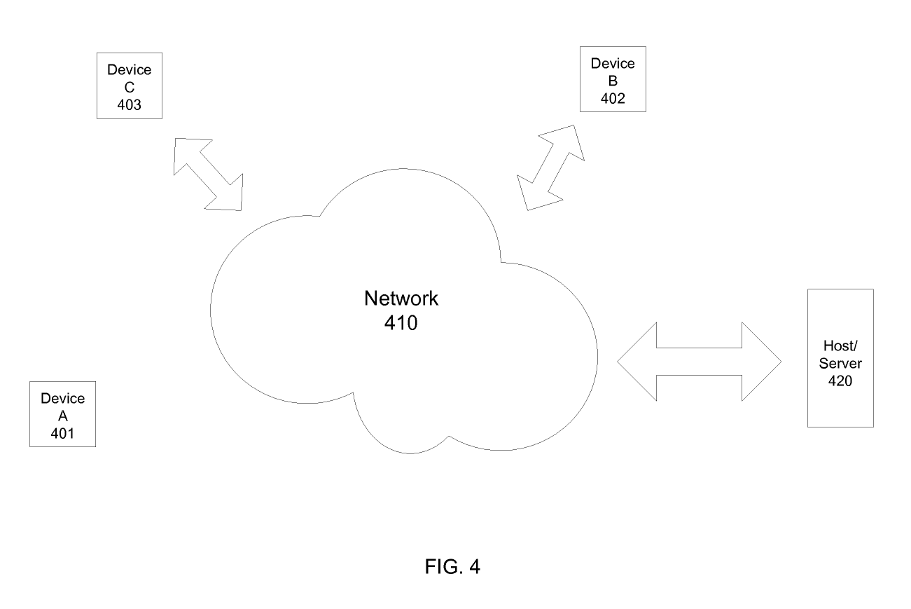

FIG. 4 illustrates an example of a non-connected host device that is not connected to a network. As FIG. 4 illustrates, a network 410 includes host devices such as device B 402, device C 403 and host/server 420. Each of device B 402, device C 403 and host/server 420 are connected in the network 410 such that data and activities such as events or state changes may be detected and/or logged in a device of network 410. In one example, host/server 420 may detect and/or log events occurring at any one of host devices device B 402 and/or device C 403. Hence, an action may be taken at device B 402 and the action may be detected at host/server 420. The host/server 420 may further log the action in a log or other storage format, if desired. Also in this example, an action or event that is performed at device A 401 may not be detected at a host device that is connected to network 410 via the network 410. If device A 401 is not connected to the network 410 as illustrated in FIG. 4, actions taken at device A 401 may not be communicated to other host devices that are connected to the network 410. Hence, the actions taken at device A 401 may not be known at device B 402, device C 403 or host/server 420, in this example.

In this example, an action may be taken at device A 401. The action may include any activity or event which may include state changes. For example, a data file may be copied, saved, duplicated, modified, printed, etc. at device A 401. However, if device A 401 is not connected to the network 410 or to host devices in network 410 (e.g., device B 402, device C 403 or host/server 420 in this example), actions taken on the data file may be performed locally at device A 401 whereas no knowledge of this action may be recorded or otherwise detected at device B 402, device C 403 or host/server 420.

In one example, an activity may be accomplished at a non-connected host device (i.e., a host device that is not connected to a network that includes other host devices) and the activity may be detected or logged at a host device that is connected to the network. For example, referring to FIG. 4, an activity may be performed at device A 401 that is not connected to network 410, however, the activity may be detected, recorded, and/or logged at any of device B 402, device C 403, and/or host/server 420, or any combination of the host devices thereof. If network 410 includes additional host devices, the activity may be detected, recorded, etc. at any of the additional host devices (or combination of additional host devices or combination of additional host devices and any of device B 402, device C 403, and/or host/server 420). In another example, the activity performed at device A 401 may be detected, recorded, and/or logged at one host device of the network 410 and may further be communicated from the one host device of the network 410 to other host devices in the network 410.

In another example, a host device may be partially connected to a network or intermittently connected to the network and activities or events occurring at the partially connected or intermittently connected host device may also be detected, logged, and/or recorded at a host device that is fully connected to the network. In this example, when a host device is partially connected or intermittently connected to a network, the host device is connected to the network at certain times or under certain conditions but may also be disconnected from the network, if desired. Hence, under certain conditions or at certain times, the host device may be disconnected from the network such that a direct connection to other host devices that are connected in the network is discontinued. The connection may be re-established when the host device is re-connected to the network.

Hence, the direct connection between the host device and host devices that are connected to the network may occur when all of the host devices are connected to the network. However, if one host device that is connected to the network is removed from the network such that the direct connection between the host device and the other host devices of the network (that are still connected to the network) is discontinued, then the direct connection between the removed host device and the other connected host devices may be severed or disconnected. In another example, the disconnection of the host device may be temporary such that the host device may be re-connected to the network at a subsequent time or when a certain condition or set of conditions exist.

Similarly, when a host device is non-connected to a network, the host device does not connect directly to the network such that direct communication between the host device and a host device that is connected to the network may not occur unless an alternate, independent path of communication exists between the host devices. Hence, in the example illustrated in FIG. 4, device A 401, which lacks any connection to device B 402, device C 403, or Host 420 via network 410 (or any other independent connection), is a non-connected host device with respect to the network 410.

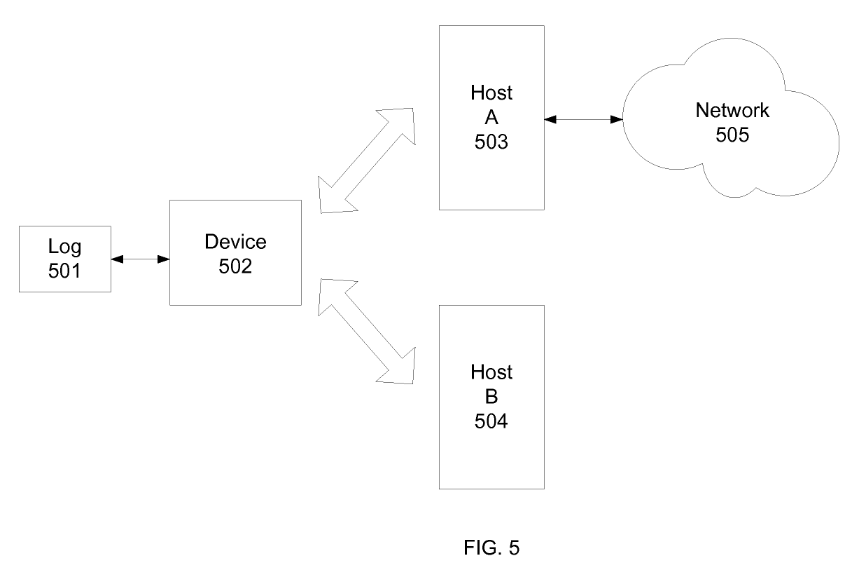

FIG. 5 illustrates an example of a non-connected host device and a fully-connected host device of a network. Alternatively, a host device may be a partially or intermittently connected host device as described further below. In this example, device 502 may include a memory that includes a log 501. In one example, the log may be stored locally on the device 502. As information is generated or received at device 502, the information may be included in the log 501. Thus, the log 501 may be updated as new or updated information is received or generated at device 502 such that the log 501 includes data pertaining to device 502 or any other desired data.

Device 502 may connect to Host A 503, as illustrated in the example of FIG. 5, and information may be exchanged between device 502 and host A 503. Host A 503 as illustrated in FIG. 5 is a fully connected host device that is connected to network 505. Thus, Host A 503 may be connected to the network 505 substantially continuously. Actions performed at fully connected Host A 503 may be observed or detected by any host device connected to network 505. For example, if an action is taken at host A 503, information corresponding to the action may be transmitted via the network 505 to any other host device connected to the network 505. Network 505 may include any number of other host devices (not shown) such that the other host devices may communicate with host A 503 via the network 505.

Device 502 may be any device that may be connected or may communicate with host A 503. For example, device 502 may be a portable device such as a communication device (e.g., phone, PDA, etc.), memory device, storage device, or any other device capable of connecting to Host A 503. In addition, device 502 may also contain a processor or CPU for controlling functions of the device 502. In one example, the device 502 may plug into the host A 503 such that data may be exchanged between device 502 and host A 503 via the connection. As one example, device 502 may be connected to host A 503 via a USB connection, however, any method of connection of devices may be used in connecting device 502 and host A 503.

Similarly, device 502 in this example may also connect with a second host device such as host B 504. In this example, host B 504 does not connect with network 505 and therefore does not communicate directly with host devices connected to network 505. For example, host A 503 is connected to network 505 and may communicate or exchange data with host devices that are connected to network 505. Host B 504 is not connected to network 505 and may not communicate or exchange data with host devices connected to network 505 because a connection between host B 504 and the network devices is not present. However, device 502 may be connected to host B 504. In this example, the connection between device 502 and host B 504 is accomplished independent of the network 505 such that device 502 does not connect to host B 504 via the network 505. Instead, device 502 connects with host B 504 via an alternate connection. For example, device 502 may be disconnected from host A 503 and may further be connected to a USB port, or any other suitable connection port or bus, on host B 504 such that a direct connection may be established between device 502 and host B 504. At the same time, the connection between device 502 and host A 503 has been terminated such that communication or data transfer or exchange between device 502 and host A 503 is suspended. However, in this example, the suspension of communication between device 502 and host A 503 may be temporary such that when a user desires the connection to be re-established, the user may connect device 502 back to host A 503 such that communication or data exchange between device 502 and host A 503 may be resumed. Additionally, if desired, the connection between device 502 and host B 504 may be discontinued prior to re-connection of device 502 to host A 503.

In another example, device 502 may be connected to host B 504 and may audit activities and events performed by host B 504. The auditing information may be stored in memory on device 502. Further, device 502 may connect directly to network 505 or to any host device connected to network 505 to provide the audit information. For example, the device 502 may generate audit information based on activities performed on host B 504 and may further communicate or report auditing records of the performed activities via a direct connection to the network 505. In one example, device 502 may be a wireless device (e.g., a cell phone) and may communicate the audit information wirelessly to the network 505 or any host device connected to network 505.

In one example of FIG. 5, host A 503 is a fully connected host device and is fully connected to network 505. Also, host B 504 is a non-connected host device such that host B 504 is not connected to the network 505 or any of the host devices in network 505. Device 502 may be connected to host A 503. This connection may be via a USB port or other connection means. While connected to host A 503, information may be transferred between host A 503 and device 502. In one example, data is transferred from host A 503 to device 502. The data being transferred may include any type of data such as, but not limited to, documents, photographs, images, videos, e-mails, etc. In addition, the data being transferred may include proprietary or sensitive information or any information of a private nature. The data may also include any information that a user may wish to keep confidential or information that has limited access. The data may also include any data which a user or administrator may wish to track for a variety of reasons.

The transfer of data from host A 503 to device 502 may be performed by a user of host A 503. For example, the user may copy information stored at host A 503 to the device 502. Host A 503 is connected to network 505. Thus, the transfer of data from host A 503 to device 502 may further be communicated to any one or more of the host devices connected to the network 505. In this example, a record indicating the transfer of data from host A 503 to device 502 may be generated and transmitted to a host device or server via the network 505. The host device or server in this example may be connected to network 505 such that the host device or server may receive and/or process the received log information indicating that data has been transferred or copied from host A 503.

The log information may include any desired information pertaining to the data or the transfer of the data. For example, the data may include a description of the type of data, date or time of the transfer, device identifier of device 502, user information of a user associated with device 502 and/or host A 503, etc. The log information may also be stored in a log 501, for example, locally at the device 502. Alternatively, the log 501 may be stored remotely. If the log 501 is stored remotely from the device 502, then the log data may be transmitted from device 502 to the location where log 501 is stored. This location may be a remote device or may be located anywhere relative to device 502.

Log 501 may be updated with the log information. Hence, the device 502 may contain a log 501 in memory and the log 501 may be updated with actions taken or events that occur at host A 503. In this example, accessing data on host A 503 and/or transferring or copying data from host A 503 to device 502 may be logged or recorded in log 501 and may be stored on device 502 (within the log 501).

In this example, the device 502 may further be disconnected from host A 503. For example, after data has been transferred from host A 503 to device 502, device 502 may store the transferred data received from host A 503 as well as store a record of the action(s) or event(s) in log 501 within device 502. The storage of transferred data in device 502 may be accomplished in a predetermined area in memory of device 502. The determination of a location within memory of device 502 may be determined based on the information received, for example. The device 502 may include an area within memory which is a partially or fully protected memory area. Also, the device 502 may include a processor or CPU that may control the storage of data within the device 502. For example, the information or data may be stored in a protected area (either partially or fully) based on a determination by the processor of a proprietary nature of the transferred information.

Device 502 may be disconnected from host A 503. For example, a user may manually remove the device 502 from the connection with host A 503 (e.g., pull device 502 from a USB connection with host A 503). After disconnecting device 502 from host A 503, the device 502 may continue to store the earlier transferred data in memory within device 502. Additionally, device 502 may store a record of the activity or event of transferring or copying data from host A 503 to device 502 within log 501. The log 501 may further be stored in memory of device 502.

The device 502 may subsequently be connected with host B 504. As FIG. 5 illustrates, host B 504 is not connected with the network 505 and is therefore not in communication with other host devices that are connected to network 505. Hence, in this example, host B 504 is a non-connected host device with respect to network 505—i.e., host B 504 is not connected to network 505 or any of the other host devices in network 505.

After connecting device 502 to host B 504 (i.e., the non-connected host device), the data stored on device 502 may be accessible to host B 504. For example, a user may copy data transferred from host A 503 and stored in memory of device 502 to host B 504 while the device 502 is connected to host B 504 but disconnected from host A 503. Further action may be taken on the copied data on host B 504. For example, host B 504 may be a personal computer that is not connected to the network 505 and data may be transferred from device 502 to the personal computer (i.e., host B 504) via device 502 and stored therein. The data may include, for example, a document or other information that may be considered proprietary or confidential or otherwise sensitive. In addition, the event of copying the data to host B 504 may be logged in log 501. For example, a record indicating that the data has been copied may be stored in log 501 and log 501 may be stored in memory of device 502. This information may include any desired additional information corresponding to the action. For example, the information may also include a time or date of data transfer, a user identifier, a device identifier (e.g., an identifier identifying host B 504), an address, location, etc. These are merely examples as any information may be included in log 501.

In one example, the data is transferred from device 502 to host B 504 and further manipulated on host B 504. In another example, the data is maintained on device 502 and is not transferred to host B 504. In this example, the data is stored and maintained on device 502 while being further manipulated or acted upon by host B 504. Any action may be taken pertaining to the data. For example, the data may include a text document and a user may edit or otherwise modify the document using an application program on host B 504 (e.g., a personal computer). The user may also print the document or transfer the document to another portable storage medium (e.g., a floppy disk, CD-ROM, etc.). The device 502 may remain connected to host B 504 (and disconnected from host A 503) during data manipulation on host B 504. Any of the actions taken on host B 504 corresponding to the data may be logged in log 501 on device 502. For example, if a user copies the data from host B 504 to a portable storage medium (e.g., floppy disk), the action of copying of the data may be entered as a record in log 501 on device 502. Hence, device 502 may detect an action being taken on host B 504 and may further generate and/or store a record in log 501 indicating the action has taken place. The record thus generated may further include additional information pertaining to the action. For example, additional information added to the record in log 501 in device 502 may include location of the transfer, identifier of any involved devices or peripheral device, time and/or date of the action, etc.

In another example, a host device may be authenticated by device 502. For example, device 502 may be connected to host A 503 and data may be transferred from host A 503 to device 502. The transferred data may be stored in memory of device 502. Also, the action of copying the data may be stored in log 501 within memory of device 502. After device 502 is disconnected from host A 503 and connected to host B 504, an authentication process may be performed for host B 504. In this example, the device 502 accesses host B 504 and determines the identity of host B 504. The identity of host B 504 may be determined based on detection of a unique identifier associated with host B 504, or any other means for determining the identity of a host device or user. The identity of the host device or user may be compared to a table of stored acceptable host devices which may also be stored on device 502. This table of stored acceptable host devices may further be received at the device 502 from network 505 or any host device connected to network 505 via host A 503 while device 502 is connected to host A 503.

The processor within device 502 in this example compares the identity of the host device (e.g., host B 504) with predetermined acceptable host devices and determines if host B 504 is acceptable to establish communication. Thus, host B 504, or any non-connected (or partially, intermittently, or fully connected) host device, may be authenticated by device 502. If the host device (e.g., host B 504) is successfully authenticated, communication may be established between device 502 and host B 504 when device 502 is physically connected to host B 504. Otherwise, communication may not be established between the host device and device 502 and data may not be transferred from device 502 to host B 504. Failure to establish communication between device 502 and a host device may likewise be logged into log 501.

As one example of tracking activity, a user may transfer a text document from Host A 503 to Host B 504 via device 502 (i.e., connect device 502 to host A 503, copy the text document from host A 503 to memory of device 502 and maintaining log 501 by storing a record in log 501 indicating that data has been copied from host A 503 to device 502, disconnecting device 502 from host A 503, connecting device 502 to host B 504, authenticating host B 504 via device 502, and copying the text document from device 502 to host B 504). The user may further modify the text document on host B 504 and may transfer the revised copy of the document from host B 504 to device 502. The document may then be stored on device 502 in memory within device 502. In addition, the memory of device 502 may be segmented or partitioned such that different segments or portions of memory of device 502 may have different levels of security or access. For example, a first portion of memory of device 502 may be an “unlocked” area in which data may freely be shared between host devices via device 502. Data stored in the “unlocked” area may be accessed by host devices that attach to device 502. In the example illustrated in FIG. 5, either host A 503 or Host B 504 may access data stored in the “unlocked” area.

The memory of device 502 may further include a “locked” area that contains secure data. This data may have limited access from host devices. Alternatively, data stored in the “locked” area may be accessed by only certain host devices that have been authenticated. Access to the locked area of memory on device 502 may be controlled by a processor on device 502. For example, host B 504 may be authenticated via device 502 as described above. After authentication of host B 504, host B 504 may access data stored in the “locked” area of memory of device 502.

In addition, the memory of device 502 may contain a “protected” area in which data within the protected area may not be accessible by a host device. For example, log 501 may be stored in the protected area of memory of device 502 such that host B 504 may not access the data. A processor within device 502 may manage the protected area to control access to the area and/or to update the log 501 to indicate actions taken on host B 504 associated with data manipulation or any actions taken on the data.

Thus, in this example, data may be transferred between a first host device connected to a network (e.g., fully connected host device) and a second host device that is not connected to the network (e.g., a non-connected host device or partially/intermittently connected host device). Any event may be performed pertaining to the data on the second host device or any other host device that is not connected to the network. The event performed may further be recorded or otherwise maintained such that a host device in the network may be informed of any details of the event. The event may include any action taken on the data or any change of state of the data. For example, the data may include a document file and the event may include printing the file, saving the file, e-mailing the file, modifying the file, viewing the file, deleting the file, printing the file, copying the file, etc. These are merely non-limiting examples of types of data and types of events or state changes that may be applied to the data.

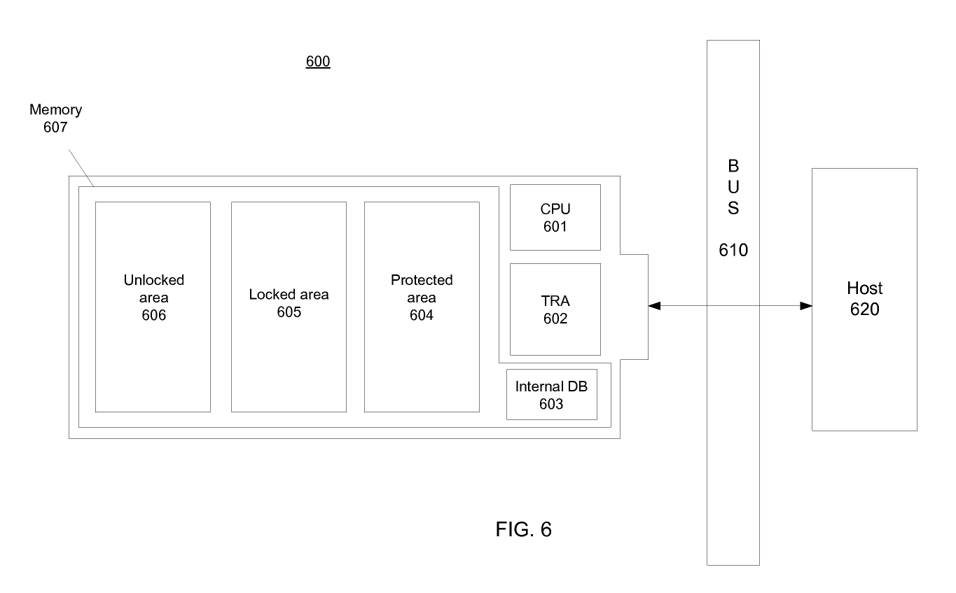

Data may be accessed, manipulated, or otherwise managed in a host device in which actions taken with respect to the data may be recorded, stored, or output to a central data management device or facility (e.g., in a log). The device for maintaining a log in which events and actions taken on host devices may be recorded on a portable or removable device. FIG. 6 illustrates an example of a device for tracking actions and/or events associated with data in a system. In this example, device 600 may connect to host 620 and may exchange data with host 620. In one example, data may be exchanged via bus 610. Bus 610 may further be within the host 620, if desired.

Device 600 may include a memory 607 and a processor or CPU 601. The CPU 601 may control data transfer between the device 600 and a host 620. Also, the CPU 601 may authenticate host 620 such that hosts that are determined to have access to data may access data on the device 600. If a host is denied access to data on device 600, then the CPU 601 may control access to data in memory 607 of device 600 for the host. For example, devices that are denied access to data on device 600 may be restricted from accessing the data via the CPU 601.

As the example of FIG. 6 illustrates, the device 600 may include portions of memory 607 for storing information. In one example, the memory 607 may include an unlocked area 606 for storing information that may be shared among host devices. For example, non-sensitive information may be stored in an unlocked area 606 of memory 607. The unlocked area 606 of memory 607 may further be monitored by the CPU 601, if desired, such that information associated with the data within the unlocked area 606 may be tracked or otherwise monitored. For example, activities performed with data stored in the unlocked area 606 may be monitored by CPU 601. This information may also be included in a log file which may be stored in any desired portion of memory of device 600, if desired.

The device 600 may also include a locked area 605 for storing secure data. Information in the locked area 605 may be managed by the CPU 601 such that a restricted access to the data within the locked area 605 may be maintained. Any data or information with restricted access may be stored in the locked area 605. Similarly, a protected area for internal data may be included in memory 607. The protected area may store information that is inaccessible by a host device such as host 620. For example, a log file containing records of activities or events performed by a device may be stored in the protected area. Alternatively or additionally, the log file may be stored in an internal database 603. The internal database 603 may also have restricted access by host devices and/or may be included within the protected area 604 of memory 607.

The device 600 may further include a tamper resistant area (TRA) 602). The TRA 602 may include any additional information such as information or data that may be predetermined. This may include, for example, policy information for performing event or activity tracking.

The device 600 may connect to a host device 620 as illustrated in the example of FIG. 6. The connection may be a direct connection via any number of connection means. One example of a connection between the device and host 620 includes connection via a USB connection. In this example, the device 600 may include a portion for plugging into host 620. The connection may further be accomplished via a bus 610.

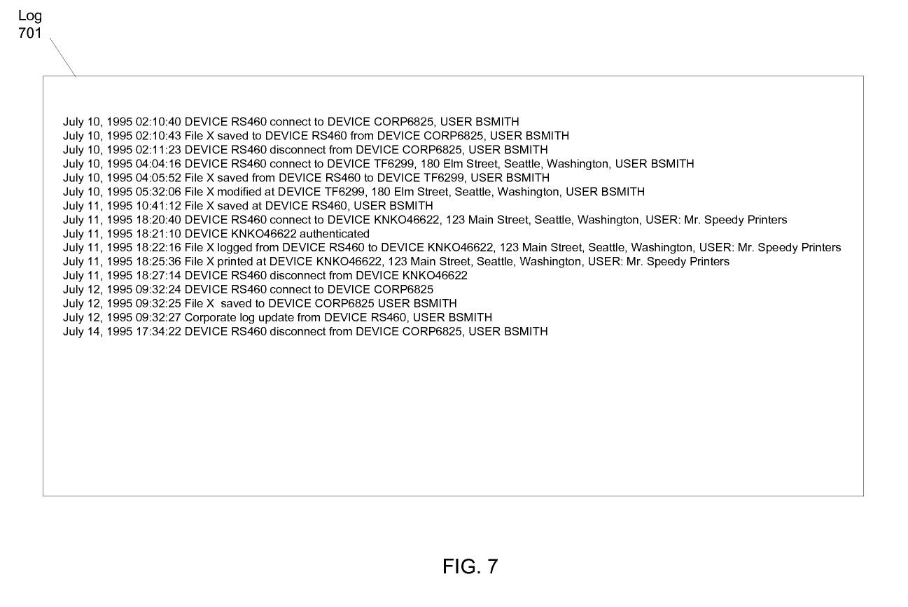

Any activity or event pertaining to data of interest may be recorded and/or stored in a log. The log may include records that may describe any aspect of interest for activities or events. This information may include, for example, a date, time, action description, location, address, telephone number, identifier, user name, etc. Any information may be included in any record of the log. FIG. 7 illustrates an example of a log file that may be stored in memory on the device such as device 600.

As FIG. 7 illustrates, the log file 701 may include data describing actions taken on data of interest. For example, the log file may include an action that is taken such as data being saved to the device, the device being connected to or disconnected from another device, identifiers that identity devices being connected or disconnected, locations of devices, users associated with devices, etc. This information may be stored on the device and may further be transmitted from the device to another device. In one example, the log information may be transmitted from the device to a fully-connected network device such as a host or server. The host or server may receive the information and may store the information centrally. This information may be accessible by an administrator to determine the status of data in the network.

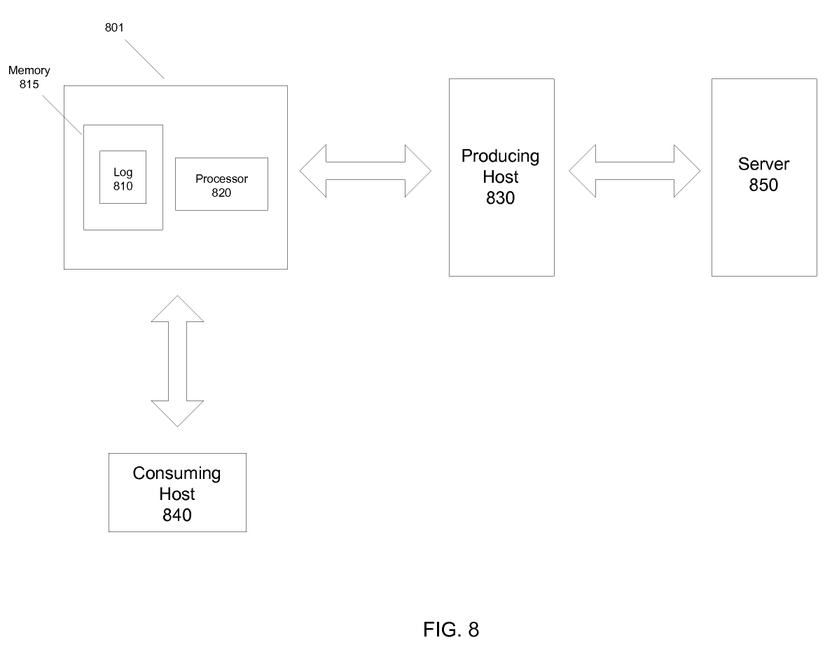

FIG. 8 is a block diagram illustrating one example of auditing of information. As the example of FIG. 8 illustrates, a device 801, which may be a portable device capable of connecting to a host device and exchanging data with the host device, contains a processor 820 and a memory 815. Also, a log 810 may be stored in memory 815. The log file may contain information of activities or events performed in conjunction with the device 801. Device 801 may be connected to a producing host 830 which may, in turn, be connected or be in communication with a server 850. The producing host 830 may generate data (i.e., produce data) and may store the data locally (i.e., on the producing host 830) or remotely on other devices that may be connected to producing host 830. For example, producing host 830 may generate data and may store the information on server 850. In addition, any activity or event performed on host 830 may be audited by device 801. For example, an action may be performed on host 830 and the action may be recorded in the log 810 stored in memory 815 of device 801. The device 801 may be any portable device that may be connected or removed from producing host 830. Hence, the device 801 may audit all actions or events of data of any host and may further store a corresponding audit log 810 containing a log of such actions in memory.

In addition, producing host 830 may receive a connection with device 801. In one example, device 801 may plug into producing host 830 via a USB connection or any other connection method. When device 801 is connected to producing host 830 such as in a physical connection or a wireless connection, data may be communicated between producing host 830 and device 801. In another example, data is communicated or exchanged between producing host 830 and device 801 after an authentication procedure in which the producing host 830 is authenticated for use with the device 801. For example, the device 801 may store authentication information in memory 815 in which an identifier of producing host 830 is matched with an identifier stored in memory 815. If device 801 determines that producing host 830 is permitted to exchange data, then data may be transferred from producing host 830 to device 801. Otherwise, producing host 830 may fail to obtain authorization to transfer data to device 801 and data transfer from producing host 830 to device 801 may be disabled or blocked. In this example, a record of the failure or success of authorization may also be stored on the device 801.

After device 801 is connected to producing host 830 and producing host 830 is authenticated as a device capable of transferring or exchanging information with device 801, data may be transferred from producing host 830 to device 801. The transferred data may be stored in memory 815. The location within memory 815 for storing the transferred data may be determined by processor 820. This determination may be based on any of a number of factors including nature of the data or information or level of importance or confidentiality of the data. For example, confidential or proprietary information may be stored in a locked area of memory based on control from the processor 820.

The device 801, after having received data from producing host 830, may be disconnected from the producing host 830. After disconnecting from producing host 830, the memory 815 of device 801 may contain the transferred data from producing host 830 and may be subsequently connected to a consuming host 840. The consuming host 840 may receive the connection with device 801 and may further receive data transferred from the device 801. In one example, the data transferred from the device 801 to the consuming host 840 may include information transferred from the producing host 830 and stored in the memory 815 of device 801.

The consuming host 840 may further be authenticated by device 801. For example, device 801 may store information pertaining to approved devices for communicating or exchanging data with device 801. This information may be stored in memory 815 of device 801. After connection of device 801 to consuming host 840, device 801 may receive an identifier associated with consuming host 840 or a user corresponding to the consuming host 840. Based on the identifier, device 801 may determine if the consuming host 840 and/or the user corresponding to consuming host 840 is approved to communicate and/or exchange data with device 801. Additionally or alternatively, the device 801 may determine, based on the identity of the consuming host 840, if the consuming host 840 is capable of performing auditing functions to track events or activities performed on the consuming host 840.

The device 801 is connected to consuming host 840 and data may be transferred from the device 801 to consuming host 840. This transferred information may include data received from producing host 830 and stored in memory 815 of the device 801. For example, a data file may be copied from producing host 830 to memory 815 of device 801. Additionally, a record may be included in a log file indicating the action of copying the data file from producing host 830 to memory 815 of device 801. The log file may be stored in memory 805 of device 801 and may be updated as additional actions or events occur pertaining to the data file.

Also in this example, the data file may be copied from the device 801 to the consuming host 840. In this example, the device 801 is connected to (e.g., plugged into or connected wirelessly) the consuming host 840 and the data file may be copied from memory 815 of the device 801 to the consuming host 840 via the connection between the device 801 and the consuming host 840. Also, the activity or event of copying the data from device 801 to consuming host 840 may be entered into the log file and stored on device 801. For example, a log file in memory 815 of device 801 may be updated to include the activity of copying the file to the consuming host 840.

The data file may further be manipulated in any way on consuming host 840. For example, if consuming host 840 is a personal computer, the data file may be modified or edited. The action of modifying or editing the data file may further be included in the log file stored in memory 815 of device 801. For example, the log file 810 may be stored in memory 815 of device 801 and may be updated to include the action of modifying or editing the data file when the data file is modified or edited. Additionally, the updated record in the log 810 may include additional information pertaining to the activity. For example, a location of the consuming host 840, a user associated with the consuming host 840, a date and/or time of the activity, etc. Any of this information or other desired information may be included in the log 810.

The user may further save the modified data file back to the device 801. The modified data file may be stored in memory 815 of device 801. In one example, the modified data file is stored in a different location within memory 815 as the log file 810. The modified data file may be stored in a shareable area of memory 815, for example, while the log file may be stored in a protected internal area of memory 815. The location of data storage may further be determined by the processor 820 based on the data being stored or the components providing the data, for example.

In this example, the consuming host 840 is not connected to the producing host 830 or the server 850. Therefore, activities and events performed at the consuming host 840 may not be known to the producing host 830 or the server 850. Additionally, other host devices may be connected to the producing host 830 and/or server 850 in a network. These other host devices are also not connected to the consuming host 840 and would therefore not have information of the activities and events performed at the consuming host 840.

However, in this example, the device 801 may be reconnected with the producing host 830 and/or server 850. After reconnection of the device 801 to producing host 830, the modified data file may be copied to the producing host 830. Also, an updated log 810 stored in device 801 may be transferred to producing host 830 and/or server 850. For example, the device 801 may be connected to producing host 830 and the log 810 may be transferred automatically to producing host 830. The log 810 contains information indicating the events or activities that occurred with respect to consuming host 840. This information may be received at producing host 830 and may further be transmitted or otherwise transferred to server 850. Thus, the server 850 may contain updated information indicating actions and events associated with the data file where the actions and events include those actions and events occurring at devices that are not connected to the server 850.

Also in this example, the producing host 830 may be a trusted system such that the producing host 830 may process the audit log 810 from the device 801. Trust of the producing host 830 may be established via an authentication process. Likewise, trust of the device 801 may also be established by performing an authentication process. For example, the device 801 may be connected to the producing host 830. Identification data for the producing host 830 may be received at the device 801. The device 801 determines, based on the identification data corresponding to the producing host 830 that the producing host 830 is a trusted entity. For example, the device 801 may maintain a database of trusted entities and corresponding identification information. The device 801 may further match the identification data corresponding to the producing host 830 with identification data of trusted entities in the database. Based on the comparison and the determination of a match between identification data of the producing host 830 and identification data of a trusted entity in the database, the device may authenticate the producing host 830 and may transmit audit information to the producing host 830 for processing.

Likewise, the producing host 830 may authenticate the device 801 via a similar authentication process. For example, the device 801 may be connected to the producing host 830. The producing host 830 may receive identification data corresponding to the device 801 and may compare the identification data of the device 801 to identification data of trusted devices. If a match is determined, the producing host 830 may process an audit log from the device 801.

In another example, portable device 801 itself may connect directly to the network or server 850 via an unauthenticated or untrusted producing host 830 connected to the server 850 or network. For example, the device 801 may be plugged into a USB port on the producing host 830. The producing host 830 may not be authenticated by the device 801 such that the producing host 830 may not be a trusted entity to the device 801. In this case, the device 801 may provide data (e.g., audit log 810) to the network or server 850 directly. For additional security, the audit log 810 and other data that may be transmitted from the device 801 to the network or server 850 may be encrypted. Hence, in this example, a device 801 may encrypt the audit log 810 and transmit the encrypted audit log 810 from memory 815 to the network or server 850 while bypassing an unauthenticated or untrusted host (e.g., producing host 830).

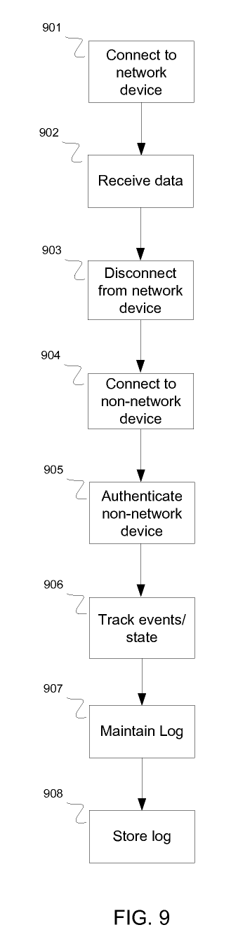

FIG. 9 is a flowchart illustrating one example of auditing. In this example, a connection is established with a network device (STEP 901). For example, a portable device capable of storing information may be connected to a network device. The network device may include any type of network device including, for example, a personal computer. The portable device may include any device capable of connecting to the network device and may include, for example, a portable storage device, a mobile telephone, etc. The connection may be accomplished via a variety of methods including, for example, plugging the portable device into the network device via a USB connection.

In STEP 902, data is received. This may include, for example, transferring data from the network device to the portable device. The transferred data may include any type of data of interest. For example, the data may include confidential information or proprietary information. In one example, a corporate employee may transfer proprietary information from a corporate computer (i.e., a network device) to the portable device. In addition, the data received at the portable device may include log information pertaining to an audit of activities or events performed associated with the data being transferred. For example, identities of network devices involved in the transfer of data, locations of the network devices, identities of users identified with the transfer or the network devices involved in the transfer of data, size of data, type of data, date/time of transfer, etc. Any desired information may be received from the network or network device at the portable device. This audit information may be stored on the portable device in memory on the portable device.

In STEP 903, the portable device may be disconnected from the network device. In addition, the portable device is disconnected from the network such that actions, activities and events performed with the portable device may not be logged or otherwise detected at the network device or other network devices that are connected to the network when the device is disconnected from the network device. The portable device may be connected to another host device (STEP 904). The other host device may not be connected to the network or to the network device. Hence, actions taken at the other host device may not be monitored or detected at the network device. Alternatively, the other host device may be a partially or intermittently connected device as described above.

In STEP 905, the other host device (i.e., non-network device) is authenticated. The portable device may contain within memory identities of host devices that are approved for data transfer or exchange with the portable device or with performing actions on the data stored on the portable device. Based on matching of identities of host devices in memory with an identity of the non-network host device, the non-network host device may be authenticated such that data may be exchanged or transferred to the non-network host device.

After authentication, events or activities which may include state changes of the data stored on the portable device or transfer of the data on the portable device to the authenticated non-network host device may be recorded and/or stored (STEPS 906-908). For example, an action may be taken on the data stored on the portable device (e.g., printing the data) or an action may be taken on data transferred from the portable device to the non-network host device (e.g., host device). Any of these actions may be detected at the portable device (STEP 906) and indicated in a record of a log file stored on the portable device (STEP 907). The log file may thus contain data describing actions and events performed on data stored on the portable device or transferred data from the portable device which may include, for example, saving, printing, e-mailing, copying, etc. This log file may be updated as additional events or activities are performed. The log file may further be stored (STEP 908), for example, on the portable device.

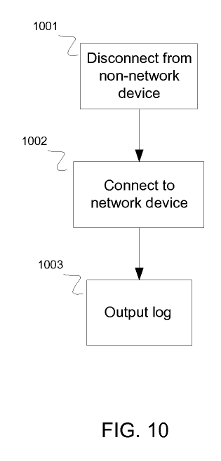

FIG. 10 is a flowchart illustrating an example of updating an audit log in a network. In this example, the portable device detects actions taken on the data such as data stored on the portable device or data transferred from the portable device to the non-network host device. The action(s) are entered into the audit log stored on the portable device. In STEP 1001, the portable device is disconnected from the non-network host device. For example, a document may be copied to the non-network host device from the portable device and may be modified on the non-network host device. The modification of the document may be recorded at the portable device in the audit log. Any additional details of the modification may also be included in the audit log including, but not limited to, date, time, location, etc. of the data or the file modification. The portable device may also store the modified document and may subsequently be disconnected from the non-network host device (STEP 1001).

In STEP 1002, the portable device may be connected to a network host device. Prior to connecting the portable device to the network host device, the network host device may not be informed of the action taken at the non-network host device. In this example, the network host device may not be informed of the file modification that occurred at the non-network host device. However, in STEP 1002, the portable device (containing the updated audit log) is connected to the network host device and the updated audit log, which contains information identifying the actions taken at the non-network host device, may be transferred from the portable device to the network host device via the connection between the portable device and the network host device (STEP 1003). In addition, any other pertinent data may be transferred from the portable device to the network host device via the connection.

Hence, in STEP 1003, the audit log is output from the portable device to the network host device. The network host device may store the audit log to maintain an updated record of the status of the transferred data. Alternatively, the audit log may be transferred from the network host device to any other host device in the network. For example, the audit log may be transferred to a host device or server connected to the network and stored in the host device or server.

In another example, the audit log is output from the portable device (STEP 1003) to a server or to a different network host device. For example, the portable device is disconnected from a non-network host device (STEP 1001) and connected to a first network host device (STEP 1002). The first network host device may be unauthenticated or may not be trusted by the portable device. In this example, the portable device may communicate the audit log directly with a second network host device such as a server. Thus, in this example, the first network host device (e.g., host device) may serve as a gateway for the portable device and the audit log is not stored in memory of the first network host device.

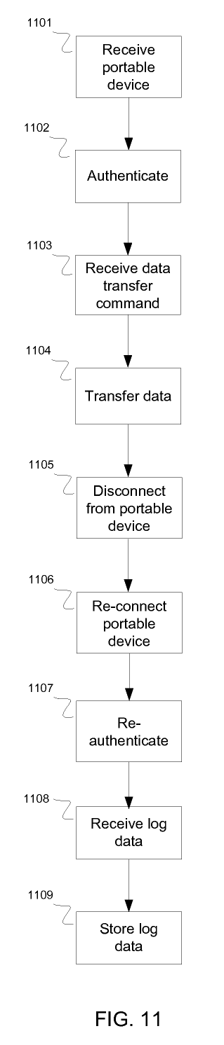

FIG. 11 is a flowchart illustrating another example of auditing events or activities. In this example, a network host device may contain a means for connection to a portable device. For example, the network host device may include USB connection in which a portable device may be connected. Alternatively, any other type of connection, including a wireless connection, may be included in the network device. In STEP 1101, a portable device is connected via the connection to the network host device.

In one example (STEP 1102), the network host device is authenticated by the portable device. The portable device may include memory for storing information on host devices that are capable of sharing information. Based on the stored information, a processor on the portable device may determine that the network host device is permitted to share or exchange data with the portable device. The network host device may then receive a command to transfer data to the portable device (STEP 1103). For example, a user may input a command to the network host device instructing the network host device to copy data to the portable device after the portable device is connected to the network host device. Responsive to the request, the network host device may transfer specified data to the portable device.

In another example (STEP 1102), the portable device connects to the network host device and authenticates a second network host device. For example, the portable device may connect to a network host device but may authenticate a server device in the network. The network host device in this example is unauthenticated and may not be a trusted entity for the portable device. The portable device may transfer data with the authenticated second network host device (e.g., audit logs, policies, etc.) while remaining connected to the unauthenticated network host device. In this example, log data or other data may be transferred from the authenticated second network host device to the portable device and stored in memory on the portable device.

Hence, in STEP 1103, in one example in which the first network host device is authenticated by the portable device, the authenticated first network host device may receive a command for data transfer. The command may include a request from a user or administrator to transfer audit log information from the first network host device to the portable device. Responsive to the command, the requested data may be transferred (STEP 1104). In another example (STEP 1103), the first network host device is connected to the portable device but the first network host device is unauthenticated. However, a second network host device such as a server may be authenticated by the portable device. In this example (STEP 1104), a request to transfer data such as an audit log may be received and, responsive to the request, the audit log may be transferred (STEP 1104) from the server to the portable device. In this example, data or information is not transferred from the unauthenticated first network host device to the portable device.

In STEP 1105, the network host device may be disconnected from the portable device. For example, a user may disconnect the portable device from the network host device such that further actions performed with the portable device may not be detected at the network host device. In STEP 1106, the portable device may be subsequently re-connected with the network host device. If actions were taken with the portable device after disconnection from the network host device (STEP 1105) but prior to re-connection of the portable device with the network host device (STEP 1106), the actions may be recorded in a log file. The log file may further be stored on the portable device and may be updated as actions are performed. Also, the log file may be stored in a predetermined location within memory of the portable device based on control of a processor on the portable device.

Upon re-connection of the portable device with the network host device (STEP 1106), the log file may be uploaded from memory of the portable device to the network host device (STEP 1107). Re-authentication may be performed by the portable device on the network host device (STEP 1107). For example, the portable device may authenticate the network host device and, responsive to the authentication, the portable device may transfer audit log information to the authenticated network host device (STEP 1108). In another example, the portable device connects to a first network host device but authenticates a second network host device. The first network host device in this example may remain an unauthenticated network host device. In this example, the portable device may transfer audit log information to the authenticated second network host device (STEP 1108) and may not transfer audit log information to the first (unauthenticated) network host device. In one example, the authenticated second network host device is a server.

The network host device (i.e., authenticated network host device) receives the log file which may include data indicating actions taken on data or events or state changes performed when the portable device was disconnected from the network host device. For example, a user may have printed a document on a non-network host device while the portable device was disconnected from the network host device. This action of printing the document may be described in the log file stored in memory of the portable device. After the portable device is re-connected to the network host device (STEP 1106), the network host device receives the log file from the portable device. Thus, the network host device may be informed of actions taken corresponding to data of interest.

In STEP 1109, the log file is stored. The network host device may store the log file and may update the log file based on further actions or events that may occur with respect to data of interest. Alternatively, the log file may be transferred to another network host device and stored at the other network host device. For example, the log file may be transferred to a host or server to store the log file centrally. The centrally stored log file may be updated as necessary.

It is understood that aspects of the present invention can take many forms and embodiments. The embodiments shown herein are intended to illustrate rather than to limit the invention, it being appreciated that variations may be made without departing from the spirit of the scope of the invention. Although illustrative embodiments of the invention have been shown and described, a wide range of modification, change and substitution is intended in the foregoing disclosure and in some instances some features of the present invention may be employed without a corresponding use of the other features. Accordingly, it is appropriate that the appended claims be construed broadly and in a manner consistent with the scope of the invention.

1. A method for tracking events in a computing system, the method comprising
receiving data from a first host device in a network;
connecting to a second host device, the second host device being at least partially non-connected with the network;
logging an event corresponding to the data in a log file, the event associated with the second host device; and
outputting the log file to a device in the network.

2. The method of claim 1 wherein the device in the network is the first host device.

3. The method of claim 1 further comprising:
connecting to the first host device prior to receiving data from the first host device; and
disconnecting from the first host device after receiving data from the first host device and before connecting to the second host device.

4. The method of claim 3 wherein the step of outputting the log file to a device in the network includes:
connecting to the first host device;
outputting the log file to a third host device.

5. The method of claim 4 wherein the step of outputting the log file to a device in the network further includes;
prior to outputting the log file to the third host device, authenticating the third host device.

6. The method of claim 4 wherein the authenticating comprises:
determining an identity of the third host device;
matching the identity of the third host device to a predetermined identity.

7. The method of claim 5 wherein the first device is unauthenticated and the log file is not stored on the first device.

8. The method of claim 3 wherein the event is performed associated with the second host device and comprises processing the data received from the first host device, the second host device being disconnected from the first host device.

9. The method of claim 8 wherein the processing includes one of printing, saving, editing, manipulating, or deleting the data received from the first host device.

10. The method of claim 1 wherein logging the event includes storing an indication of an occurrence of the event in the log file.

11. The method of claim 10 wherein the log file is stored remotely from the first host device and the second host device.

12. The method of claim 10 wherein the step of logging the event further includes identifying an identity associated with the second host device and recording the identity in the log file.

13. The method of claim 12 wherein the identity includes an identity of the second host device or an identity of a user corresponding to the second host device.

14. The method of claim 1 further comprising disconnecting from the second host device after logging the event and before outputting the log file.

15. The method of claim 14 further comprising connecting to the first host device after disconnecting from the second host device and before outputting the log file.

16. The method of claim 15 wherein outputting the log file includes outputting the log file to the first host device and wherein the second host device is non-connected with the network.

17. The method of claim 1 further comprising:
connecting to the first host device prior to receiving data from the first host device;
disconnecting from the first host device after receiving data from the first host device and before connecting to the second host device;
authenticating the second host device, wherein the event is performed based on the authenticating;
disconnecting from the second host device after logging the event and before outputting the log file;
connecting to the first host device after disconnecting from the second host device and before outputting the log file,
wherein outputting the log file includes outputting the log file to the first host device.

18. The method of claim 17 wherein the first host device is not connected to the second host device.

19. A device for tracking events in a computing system, the device comprising:
a processor;
a memory for storing data and comprising a log file,
wherein the device is connectable to a first host device and wherein events corresponding to the data on the first host device is recorded in the log file and
wherein the device is connectable to a second host device and transfers the log file to a host device after connecting to the second host device and disconnecting from the first host device.

20. The device of claim 19 wherein the device transfers the log file to a third host device via the second host device after connecting to the second host device, the device further authenticating the third device, and wherein the log file is non-accessible to the second host device.
